(19) United States
(12) Patent Application Publication
(10) Pub. No.: US 2016/0143705 A1
(43) Pub. Date: May 26, 2016

(54) Methods and Devices for Treating Root Canals of Teeth

(71) Applicants: David J. Clark, Lakewood, WA (US); Jeremy Henderson, Burien, WA (US)

(72) Inventors: David J. Clark, Lakewood, WA (US); Jeremy Henderson, Burien, WA (US)

(21) Appl. No.: 14/949,079

(22) Filed: Nov. 23, 2015

Related U.S. Application Data
(60) Provisional application No. 62/083,023, filed on Nov. 21, 2014.

(51) Int. Cl. A61C 5/02; A61C 3/025

(52) U.S. Cl. CPC A61C 5/023; A61C 3/025

(57) ABSTRACT

The present invention relates to methods and devices for treating root canals of teeth. The method removes pulp tissue from a pulp cavity of a tooth by creating an endodontic access cavity in the tooth with only partial deroofing of a pulp chamber of the pulp cavity; and removing pulp tissue that remains in coronal areas and pericervical dentin of the tooth, without removal of neighboring hard tissue. The device can remove pulp tissue from a pulp cavity of a tooth. The device includes a source of carrier fluid; a supply of particles; and a nozzle having an inlet in fluid communication with the source of carrier fluid and the supply of particles. The nozzle has an outlet for spraying a mixture of the carrier fluid and the particles. An outlet axis of the outlet of the nozzle is positioned at an acute angle with respect to an inlet axis of the inlet of the nozzle.

### CROSS-REFERENCES TO RELATED APPLICATIONS

This application claims priority from U.S. Patent Application No. 62/083,023 filed Nov. 21, 2014.

### STATEMENT REGARDING FEDERALLY SPONSORED RESEARCH

Not Applicable.

### BACKGROUND OF THE INVENTION

1. Field of the Invention

The present invention relates to methods and devices for treating root canals of teeth.

2. Description of the Related Art

The inner portion of a tooth includes a pulp cavity that contains the pulp of the tooth. The pulp includes connective tissue, blood vessels, cells, and nerve endings. The pulp cavity comprises an upper pulp chamber and root canals that extend to the apical section of the tooth deeper into the jaw. The outer visible portion of the tooth is referred to as the crown and has a covering of enamel. The hard enamel protects softer dentinal tissues in the upper portion of the tooth. The dentin tissue contains a matrix of minute hydroxyapatite tubules interspersed with collagen fibers that surround and protect the tooth pulp. The outer non-visible portion of the tooth root is covered with cementum, a thin hard tissue that joins the root to the surrounding bone through Sharpey's fibers.

When dental caries are found in the enamel portion of a tooth, a dental professional will remove the caries to prevent further decay of the tooth. Then, the cavity preparation is filled. However, in some instances, the dental caries may be so deep that it penetrates to the dentin tissue. Bacteria and other microorganisms can then migrate into the pulp tissue. As a result, abscesses or inflammation may form in the pulp, and eventually in the periapical tissues surrounding the root apex. Dental professionals use root canal treatment procedures to remove the infected tissue from the pulp chamber and root canals of the tooth and replace it with an inert, biocompatible material.

Typically, root canal treatment methods first involve drilling an opening in the crown of the tooth to provide access to the pulp chamber. Then, endodontic files are used to remove the pulp and clean and shape the root canals. After using the files, an irrigant may be used to remove the smear layer created by the files. A sealer is coated on the wall of the root canals and then, the root canals are filled with a filling material. This sealing of the roots ideally prevents bacteria and other microorganisms from re-entering and causing infection of the living tissue surrounding the root tip. As a final step, the pulp chamber and opening in the crown of the tooth are sealed with a dental material.

In the 1970's, Dr. Herb Schilder at Boston University School of Dentistry began to advocate for aggressive opening of teeth to perform root canals. This facilitated a more efficient treatment and was especially helpful to remove residual pulp tissue in the pulp horn and soffit areas of bicuspids and molars. Traditional endodontic cavity (TEC) designs for different tooth types have remained unchanged for decades with only minor modifications. Unfortunately, the removal of a tooth structure, coronal to the pulp chamber, along the chamber walls, and around canal orifices, in a TEC design undermines the resistance of the tooth to fracture under functional loads. This has led to forty years of tooth carnage as the teeth have been essentially hollowed out in the name of expediency and to be more thorough in the cleaning, shaping, and obturation of root canals. The numbers of root fractures and the breaking off of crowned and root canal teeth has skyrocketed since that time.

As detailed in Clark and Khademi, “Modern molar endodontic access and directed dentin conservation”, Dent Clin North Am. 2010; 54: 249-273, and in Clark and Khademi, “Case studies in modern molar endodontic access and directed dentin conservation”, Dent Clin North Am. 2010; 54: 275-289, Dr. David Clark (an inventor of the present application) teamed up with a leading endodontist Dr. John Khademi and proposed a reversal of this destructive trend of TEC designs. Clark and Khademi modified the TEC design to minimize tooth structure removal. In a departure from the completely unroofed, coronally divergent, straight-line access to canal curvatures in a TEC design, the conservative endodontic cavity (CEC) of Clark and Khademi preserves some of the chamber roof and pericervical dentin. Pericervical dentin (PCD) is defined as the dentin near the alveolar crest. This critical zone, roughly 4 millimeters coronal to the crestal bone and extending 4 millimeters apical to crestal bone, is crucial to transferring load from the occlusal table to the root, and much of the PCD is irreplaceable. Long-term retention of the tooth and resistance to fracturing are directly related to the amount of residual tooth structure. The more dentin is kept, the longer the tooth is kept. Conservative endodontic cavities preserve more of the natural tooth and the second moment of inertia, or “moment”, afforded by the pulp chamber wall and the pulp chamber roof.

These articles of Clark and Khademi led to a furious debate, and a landmark research article published in the leading peer reviewed endodontic journal, the Journal of Endodontics. See, Krishan et al., “Impacts of Conservative Endodontic Cavity on Root Canal Instrumentation Efficacy and Resistance to Fracture Assessed in Incisors, Premolars, and Molars”, Journal of Endodontics, Volume 40, Issue 8, Pages 1160-1166, August 2014. The Krishan et al. research was done in a carefully controlled study, and showed that the CEO was similar to the control tooth (no cavity-virgin tooth). In contrast, the traditional endodontic cavity (TEC) showed significantly lower mean load failures to fracture. This study of Krishan et al. exhorted the endodontic specialty to move toward the CEC.

One of the chief concerns of dentists that perform CEC, and detractors of CEC, is the residual pulp tissue that clings tenaciously to acute angles in the pulp chamber, e.g., the pulp horns. Leaving this tissue behind is anathema to the endodontic community.

Therefore, an advancement is needed in the endodontic art and science of removal of pulp tissue fragments bound to these acute angles inside of the pulp chamber. These areas of pericervical dentin must be maintained if dentists are to keep the tooth strong, but the challenge is that dentists must adequately clean these tiny “corners” without destroying those important corners in the process.

### SUMMARY OF THE INVENTION

The invention meets the foregoing needs by providing improved methods and devices for treating root canals of teeth.

In one aspect, the invention comprises the removal of the soft pulp tissue that remains in the coronal areas and pericervical dentin of teeth after a conservative endodontic cavity is performed, without the removal of the neighboring hard tissue.

In another aspect, the invention provides a device for the removal of the soft pulp tissue that remains in the coronal areas and pericervical dentin of teeth after a conservative endodontic cavity is performed, wherein the device uses mild air water high pressure spray that involves a bend in the nozzle that is at an acute angle to the nozzle, from 89 degrees to 1 degree.

In another aspect, the invention provides a device for the removal of the soft pulp tissue that remains in the coronal areas and pericervical dentin of teeth after a conservative endodontic cavity is performed, wherein the device uses an advanced design of abrasive particles to allow a severe change in the microtubes carrying the microparticles such as aluminum trihydroxide.

In another aspect, the invention provides a device for the removal of the soft pulp tissue that remains in the coronal areas and pericervical dentin of teeth after a conservative endodontic cavity is performed, wherein the device uses a modification of current water/particle mixing that occurs currently at the orifice, to a staggered orifice allowing a smaller nozzle that can double over on itself inside of an endodontic access cavity space smaller than 2 millimeters by 2 millimeters.

In another aspect, the invention provides a device for the removal of the soft pulp tissue that remains in the coronal areas and pericervical dentin of teeth after a conservative endodontic cavity is performed, wherein the device includes a tip that can be inserted into the 2 millimeter by 2 millimeter endodontic access cavity space and then temporarily upturn allowing for an acute angle after insertion, and then retract the bend allowing removal of the tip from the 2 millimeter by 2 millimeter endodontic access cavity space.

In another aspect, the invention provides a device for the removal of the soft pulp tissue that remains in the coronal areas and pericervical dentin of teeth after a conservative endodontic cavity is performed, wherein the device includes micromechanical spinning brushes.

In another aspect, the invention provides a device for the removal of the soft pulp tissue that remains in the coronal areas and pericervical dentin of teeth after a conservative endodontic cavity is performed, wherein the device is an ultrasonic back action non-cutting instrument.

The invention may have any combination of the above features.

The features, aspects, and advantages of the present invention will become better understood upon consideration of the following detailed description, drawings and appended claims.

### BRIEF DESCRIPTION OF THE DRAWINGS

FIG. 1 is a cross-sectional view depicting a traditional endodontic cavity design in a tooth with the removal of a tooth structure coronal to the pulp horns of the pulp chamber.

FIG. 2 is a radiograph showing a traditional endodontic cavity with dental filling material (white area).

FIG. 3 is a cross-sectional view depicting a tooth with a conservative endodontic cavity undergoing removal of pulp tissue in a pulp horn using a device according to the invention.

FIG. 4 is an enlarged cross-sectional view of the tooth of FIG. 3 along line 4-4 of FIG. 3.

FIG. 5 is a side view of the end section of a device according to the invention for removing pulp tissue from a tooth.

FIG. 6 is a side view of a nozzle being installed on the end section of another device according to the invention for removing pulp tissue from a tooth.

FIG. 7 is a side view of the device of FIG. 5 removing pulp tissue from a tooth.

FIG. 8 is another side view of the device of FIG. 5 showing an overall nozzle transverse distance D.

FIG. 9 is a side view of yet another device according to the invention for removing pulp tissue from a tooth.

FIG. 10 is a side view of still another device according to the invention for removing pulp tissue from a tooth.

FIG. 11 is a side view of yet another device according to the invention for removing pulp tissue from a tooth.

Like reference numerals will be used to refer to like parts from Figure to Figure in the following description of the drawings.

### DETAILED DESCRIPTION OF THE INVENTION

The invention provides improved methods and devices for treating root canals of teeth.

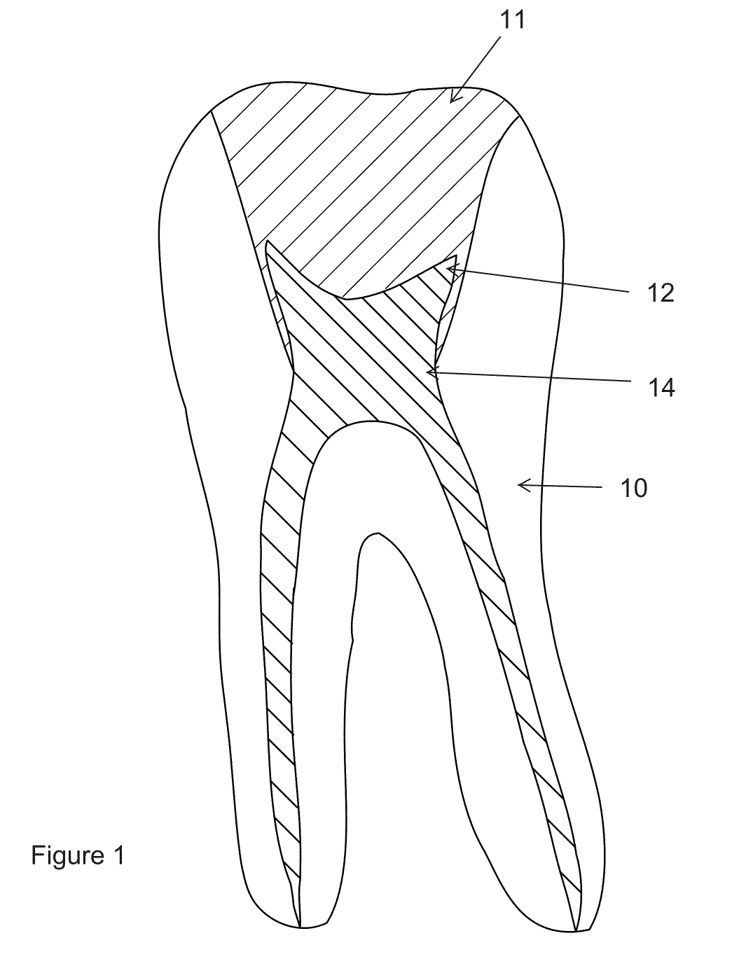

FIG. 1 is a cross-sectional view depicting a traditional endodontic cavity design in a tooth 10 with the removal of a tooth structure 11 coronal to the pulp horns 12 of the pulp chamber 14.

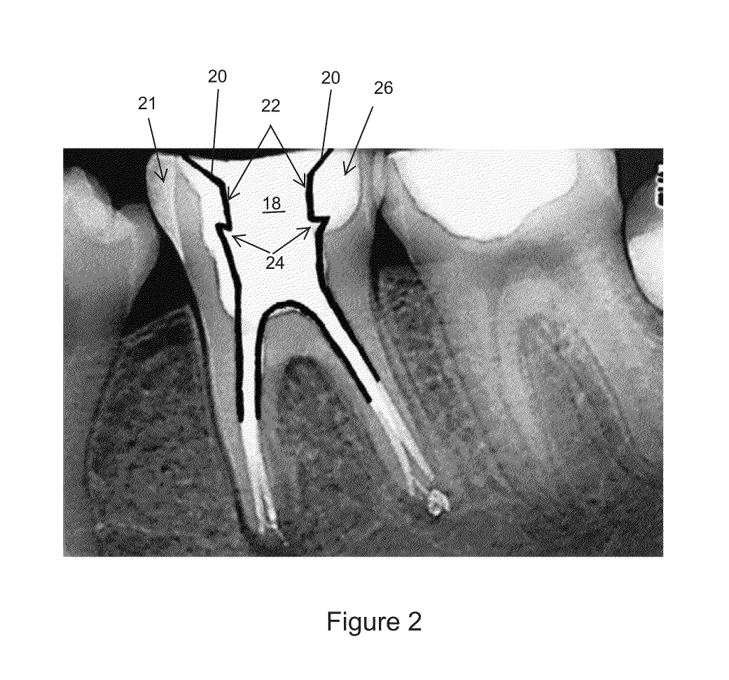

FIG. 2 is a radiograph showing a traditional endodontic cavity with dental filling material 18 (white area). Note section 26 of the dental filling material 18 showing generous removal of pericervical dentin. The wholesale loss of pericervical dentin has reduced the value of this tooth to the point that, when the tooth becomes symptomatic, extraction and replacement with an implant is a better option. An alternative model of endodontic access is superimposed as line 20 over the tooth 21 in FIG. 2. Line 20 is a more appropriate access shape. Partial deroofing and maintenance of a robust amount of pericervical dentin is demonstrated by line 20. A soffit 22 that includes pulp horns 24 on mesial and distal is depicted in line 20.

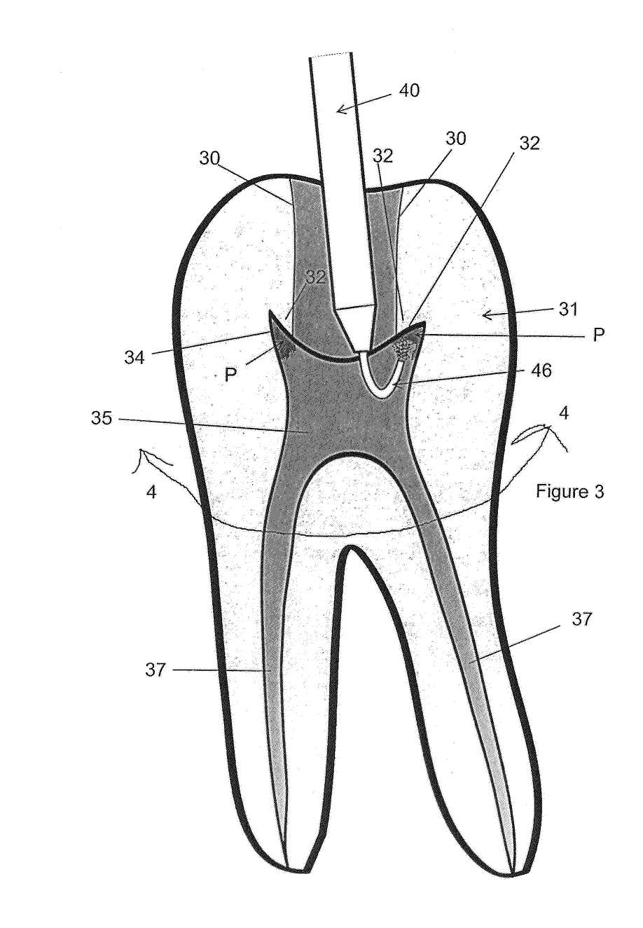

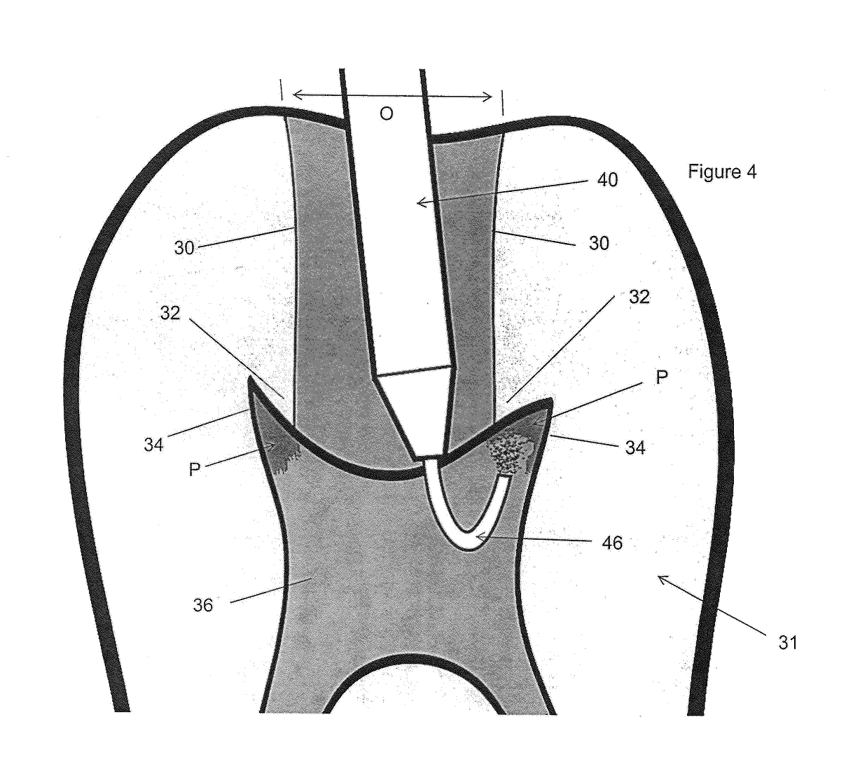

FIGS. 3 and 4 are cross-sectional views depicting a tooth 31 with a conservative endodontic cavity (CEO). Partial deroofing and maintenance of a robust amount of pericervical dentin (PCD) is demonstrated by line 30. A soffit 32 that includes pulp horns 34 of the pulp chamber 36 on mesial and distal is depicted in line 30. Root canals 37 and the pulp chamber 36 form the pulp cavity.

Referring now to FIGS. 3-5 and 8, one non-limiting example device 40 of the invention is used for removing pulp tissue P from the pulp horns 34 of the pulp chamber 36 in an example method according to the invention. The device 40 has a handle 42 supporting a conduit 43 which is a source of carrier fluid and a conduit 44 which directs a supply of particles. The conduits 43, 44 may be microtubes. The device 40 includes a nozzle 46 having an inlet 48 in fluid communication with the conduits 43, 44. The nozzle also has an outlet 47 for spraying a mixture of the carrier fluid and the particles. The particles may have an average particle size of 50 to 250 microns. The particles may comprise aluminum trihydroxide. The carrier fluid may be water. Optionally, the carrier fluid may be used alone (i.e., without particles).

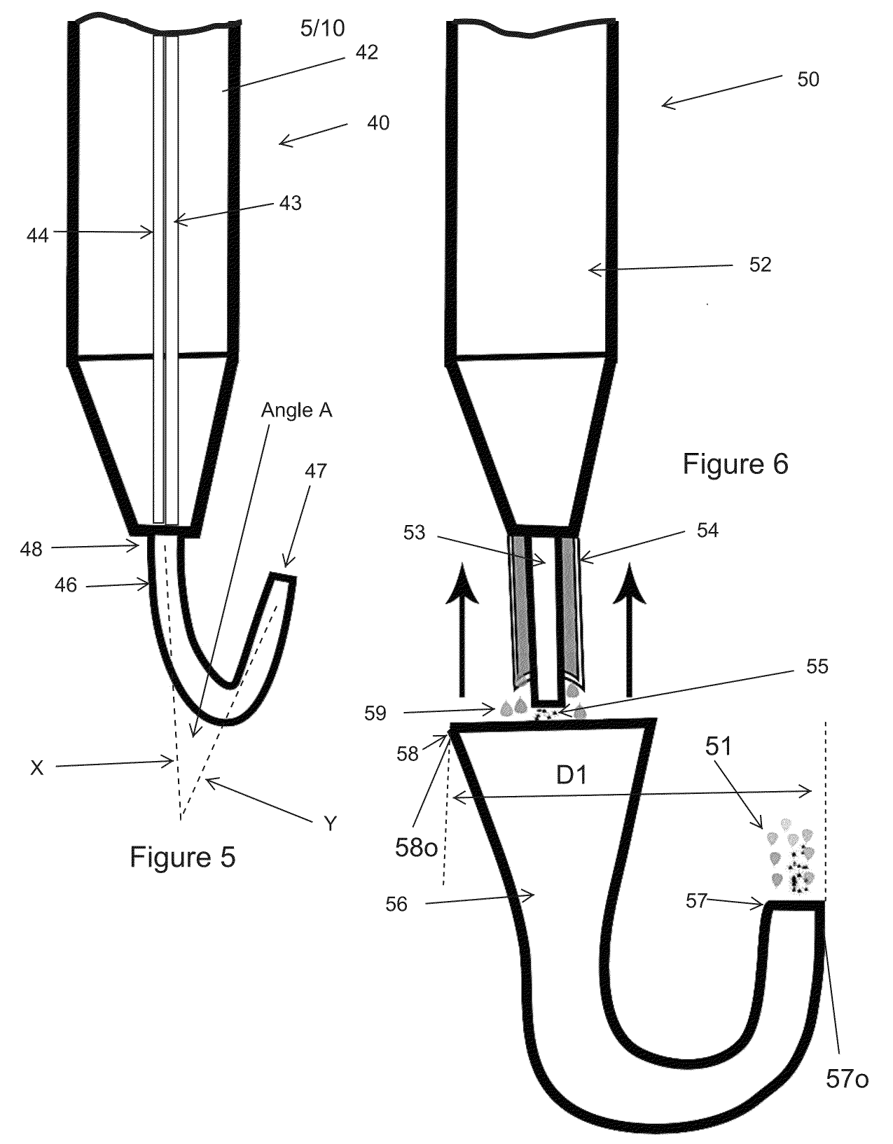

Looking at FIG. 5, an outlet axis Y of the outlet 47 of the nozzle 46 of the device 40 is positioned at an acute angle A with respect to an inlet axis X of the inlet 48 of the nozzle 46. The acute angle can be in a range of 15 to 75 degrees, more preferably in a range of 25 to 65 degrees, and more preferably in a range of 35 to 55 degrees. The acute angle provides a severe change in flow path direction of the carrier fluid and the particles. As shown in FIGS. 3 and 4, the acute angle allows the outlet 47 of the nozzle 46 to direct a mixture of the carrier fluid and the particles in a back action spraying technique to debride pulp tissue P from the pulp horns 34 of the pulp chamber 36, without the removal of the neighboring hard tissue (e.g., dentin). The device 40 may remove all non-dentin material from the pulp horns 34. The device 40 may be rotated 180 degrees to debride pulp tissue from the other pulp horn 34.

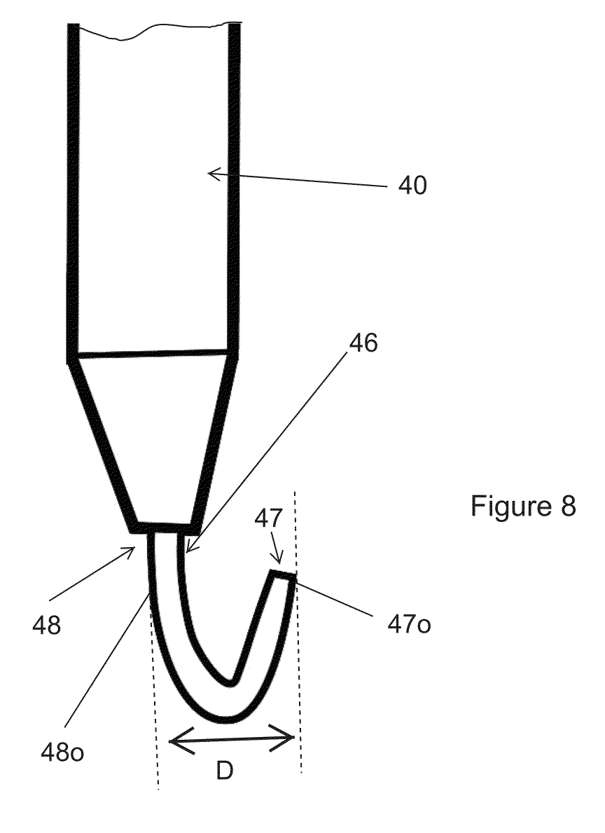

Looking at FIG. 8, the outlet 47 of the nozzle 46 has a first outer surface 47o opposite a second outer surface 480 of the inlet 48 of the nozzle 46. The first outer surface 47o and the second outer surface 48o face away from each other, and a distance D from the first outer surface 47o to the second outer surface 48o is less than three millimeters, more preferably less than two millimeters, and optionally less than one millimeter. By structuring the nozzle 46 with this distance D, the nozzle 46 can be inserted through an opening of inside dimension O (see FIG. 4) of an endodontic access cavity C.

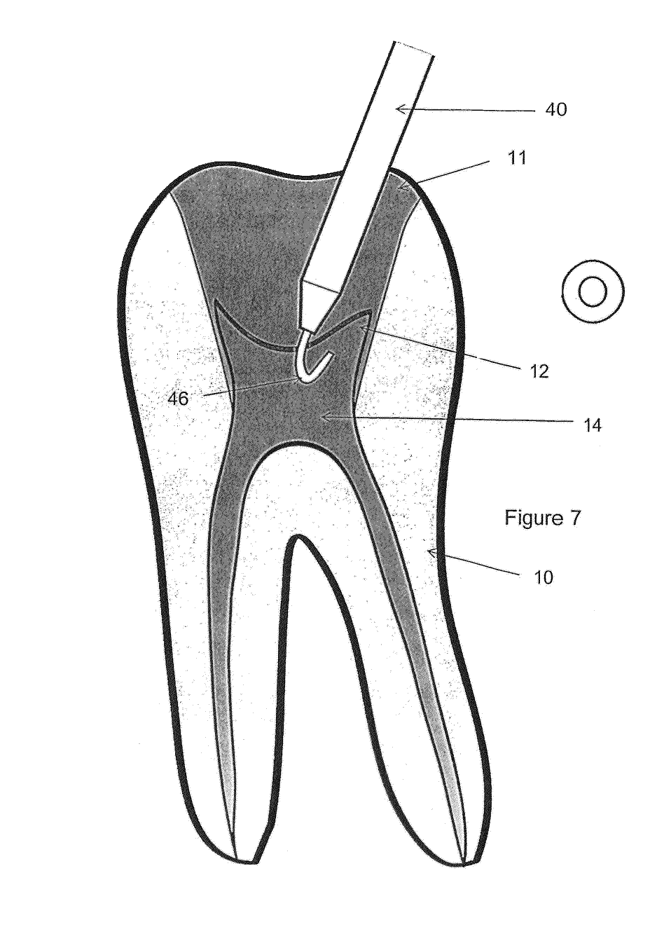

FIG. 7 shows that the device 40 may also be used with a traditional endodontic cavity (TEC) design as in FIG. 1.

FIG. 6 is a side view of another non-limiting example device 50 of the invention that can be used for removing pulp tissue P from the pulp horns 34 of the pulp chamber 36 in an example method according to the invention. The device 50 has a handle 52 supporting a conduit 53 which is a source of carrier fluid 55 and a conduit 54 which directs a supply of particles 59. The device 50 includes a removable nozzle 56 having an inlet 58 in fluid communication with the conduits 53, 54. The nozzle 56 also has an outlet 57 for spraying a mixture 51 of the carrier fluid and the particles. The particles may have an average particle size of 50 to 250 microns. The particles may comprise aluminum trihydroxide. The carrier fluid may be water. An outlet axis of the outlet 57 of the nozzle 56 of the device 50 may positioned at an acute angle with respect to an inlet axis of the inlet 58 of the nozzle 56 as in the embodiment of FIG. 5. The acute angle can be in a range of 15 to 75 degrees, more preferably in a range of 25 to 65 degrees, and more preferably in a range of 35 to 55 degrees. The outlet 57 of the nozzle 56 can direct a mixture 51 of the carrier fluid and the particles to debride pulp tissue P from the pulp horns 34 of the pulp chamber 36. The outlet 57 of the nozzle 56 has a first outer surface 570 opposite a second outer surface 580 of the inlet 58 of the nozzle 56. The first outer surface 57o and the second outer surface 58o face away from each other, and a distance D1 from the first outer surface 57o to the second outer surface 58 is less than three millimeters, more preferably less than two millimeters, and optionally less than one millimeter. By structuring the nozzle 56 with this distance D1, the nozzle 56 can be inserted through an opening of inside dimension O (see FIG. 4) of an endodontic access cavity C.

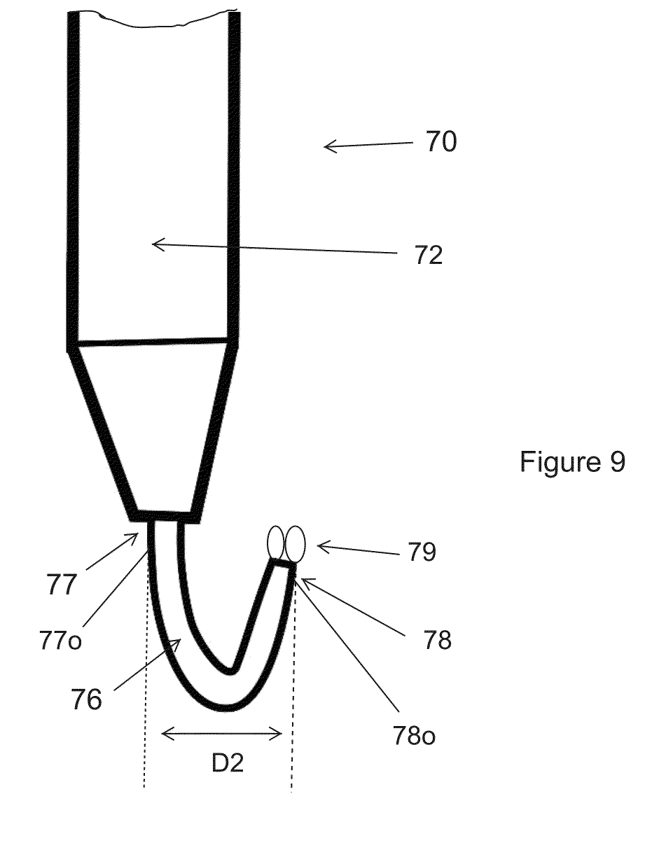

FIG. 9 is a side view of another non-limiting example device 70 of the invention that can be used for removing pulp tissue P from the pulp horns 34 of the pulp chamber 36 in an example method according to the invention. The device 70 includes a handle 72 and a tip 76 having a distal end 77 and a proximal end 78 connected to the handle 72. One or more micromechanical spinning brushes 79 (two in this non-limiting example) are attached to the distal end 77 of the tip 76. The spinning brushes 79 can debride pulp tissue P from the pulp horns 34 of the pulp chamber 36. Each spinning brush 79 may have a hardness less than a hardness of dentin, wherein dentin has a hardness of 3-4 on the Mohs hardness scale. In a similar arrangement as the nozzle 46 of the embodiment of FIG. 5, the distal end 77 of the tip 76 is positioned at an acute angle with respect to the proximal end 78 of the tip 76. The acute angle can be in a range of 15 to 75 degrees, more preferably in a range of 25 to 65 degrees, more preferably in a range of 35 to 55 degrees. The tip 76 has a first outer surface 770 opposite a second outer surface 780 of the tip 76. The first outer surface 77o and the second outer surface 78o face away from each other, and a distance D2 from the first outer surface 77o to the second outer surface 78o is less than three millimeters, more preferably less than two millimeters, and optionally less than one millimeter. By structuring the tip 76 with this distance D2, the tip 76 can be inserted through an opening of inside dimension O (see FIG. 4) of an endodontic access cavity C.

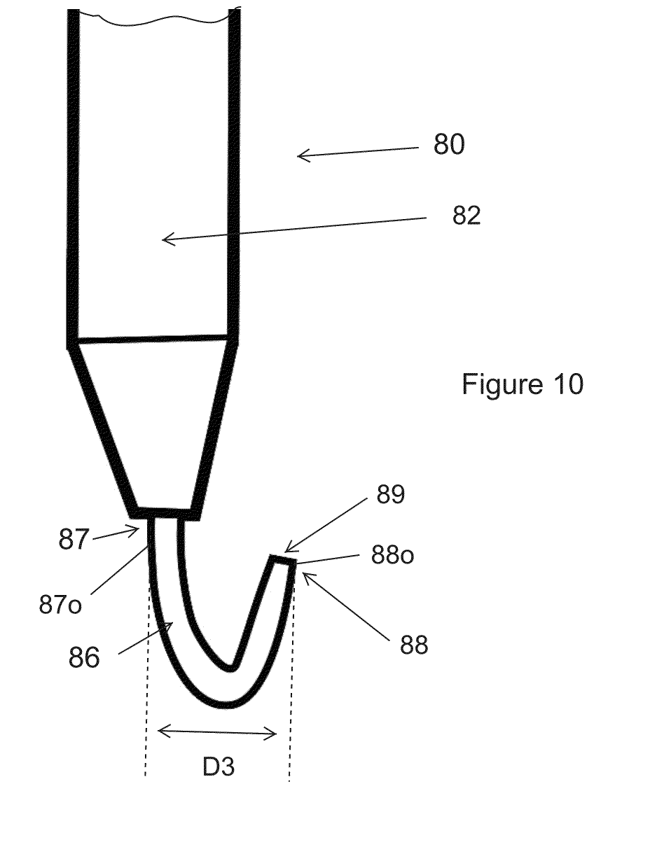

FIG. 10 is a side view of another non-limiting example device 80 of the invention that can be used for removing pulp tissue P from the pulp horns 34 of the pulp chamber 36 in an example method according to the invention. The device 80 includes a handle 82 and a tip 86 having a distal end 87 and a proximal end 88 connected to the handle 82. A cutting edge 89 is disposed the distal end 87 of the tip 86. The cutting edge 89 can debride pulp tissue P from the pulp horns 34 of the pulp chamber 36. The cutting edge 89 may have a hardness less than a hardness of dentin, wherein dentin has a hardness of 3-4 on the Mohs hardness scale. In a similar arrangement as the nozzle 46 of the embodiment of FIG. 5, the distal end 87 of the tip 86 is positioned at an acute angle with respect to the proximal end 88 of the tip 86. The acute angle can be in a range of 15 to 75 degrees, more preferably in a range of 25 to 65 degrees, more preferably in a range of 35 to 55 degrees. The tip 86 has a first outer surface 87o opposite a second outer surface 88o of the tip 86. The first outer surface 87o and the second outer surface 88o face away from each other, and a distance D3 from the first outer surface 87o to the second outer surface 88o is less than three millimeters, more preferably less than two millimeters, and optionally less than one millimeter. By structuring the tip 86 with this distance D3, the tip 86 can be inserted through an opening of inside dimension O (see FIG. 4) of an endodontic access cavity C.

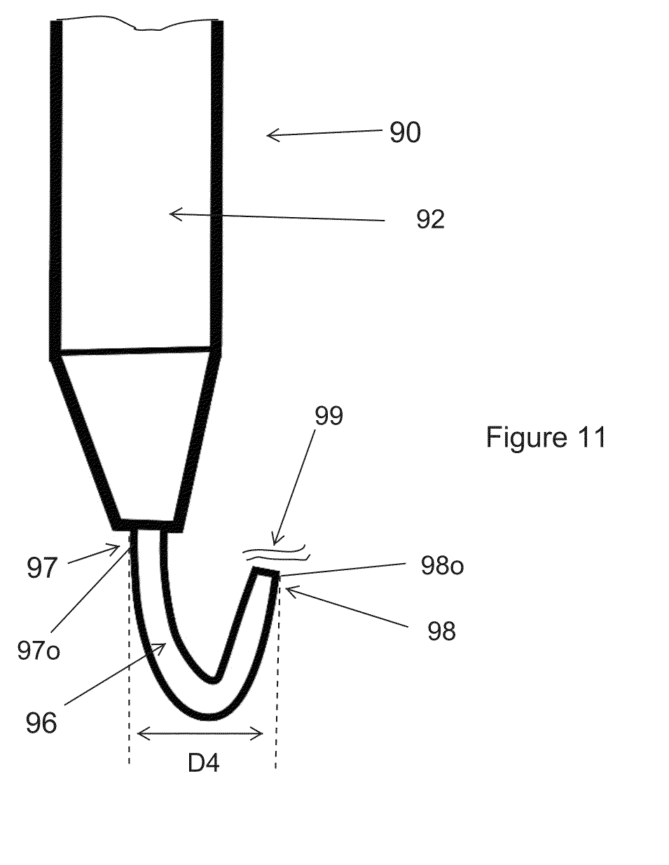

FIG. 11 is a side view of another non-limiting example device 90 of the invention that can be used for removing pulp tissue P from the pulp horns 34 of the pulp chamber 36 in an example method according to the invention. The device 90 includes a handle 92 and a tip 96 having a distal end 97 and a proximal end 98 connected to the handle 92. The distal end 97 of the tip 96 emits ultrasonic waves 99. The ultrasonic waves 99 can debride pulp tissue P from the pulp horns 34 of the pulp chamber 36. In a similar arrangement as the nozzle 46 of the embodiment of FIG. 5, the distal end 97 of the tip 96 is positioned at an acute angle with respect to the proximal end 98 of the tip 96. The acute angle can be in a range of 15 to 75 degrees, more preferably in a range of 25 to 65 degrees, more preferably in a range of 35 to 55 degrees. The tip 96 has a first outer surface 97o opposite a second outer surface 98o of the tip 96. The first outer surface 97o and the second outer surface 98o face away from each other, and a distance D4 from the first outer surface 97o to the second outer surface 98o is less than three millimeters, more preferably less than two millimeters, and optionally less than one millimeter. By structuring the tip 96 with this distance D4, the tip 96 can be inserted through an opening of inside dimension O (see FIG. 4) of an endodontic access cavity C.

Thus, the invention provides methods and devices for treating root canals of teeth. The methods and devices facilitate removal of pulp tissue fragments bound to acute angles inside of the pulp chamber. Areas of pericervical dentin are maintained in order to keep the tooth strong. The methods and devices allow dentists to adequately clean these tiny “corners” without destroying those important corners in the process.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A method for removing pulp tissue from a pulp cavity of a tooth, the method comprising:
creating an endodontic access cavity in the tooth with only partial deroofing of a pulp chamber of the pulp cavity; and
removing pulp tissue that remains in coronal areas and pericervical dentin of the tooth, without removal of neighboring hard tissue.

2. The method of claim 1 wherein:
the hard tissue is pericervical dentin.

3. The method of claim 1 wherein:
the partial deroofing creates a soffit adjacent the pulp chamber, the soffit and the pulp chamber at least partially surrounding a pulp horn.

4. The method of claim 3 wherein:
the method comprises removing pulp tissue that remains in the pulp horn.

5. The method of claim 3 wherein:
the method comprises removing pulp tissue that remains in the pulp horn by directing a fluid into the pulp horn.

6. The method of claim 5 wherein:
the fluid includes entrained particles.

7. The method of claim 5 wherein:
the fluid flows through a nozzle having an inlet and an outlet, the nozzle having a bend in the nozzle, the bend defining an acute angle between an axis of the inlet and an axis of the outlet.

8. The method of claim 5 wherein:
the fluid includes an advanced design of abrasive microparticles to allow a severe change in flow path in microtubes carrying the microparticles.

9. The method of claim 18 wherein:
the microparticles comprise aluminum trihydroxide.

10. The method of claim 3 wherein:
the method comprises removing pulp tissue that remains in the pulp horn by contacting pulp tissue that remains in the pulp horn with a spinning brush.

11. The method of claim 3 wherein:
the method comprises removing pulp tissue that remains in the pulp horn by contacting pulp tissue that remains in the pulp horn with a cutting instrument.

12. The method of claim 11 wherein:
the cutting instrument has a hardness less than a hardness of dentin.

13. The method of claim 3 wherein:
the method comprises removing pulp tissue that remains in the pulp horn by directing a fluid from a staggered orifice of a device into the pulp horn, the staggered orifice allowing a smaller nozzle that can double over on itself inside the endodontic access cavity when the endodontic access cavity has a space smaller than 2 millimeters by 2 millimeters.

14. The method of claim 3 wherein:
the method comprises removing pulp tissue that remains in the pulp horn by directing a fluid from a tip of a device into the pulp horn, wherein the tip can be inserted into a 2 millimeter by 2 millimeter space of the endodontic access cavity and then temporarily upturn allowing for an acute angle bend in the tip after insertion, and wherein the tip can then retract the bend allowing removal of the tip from the 2 millimeter by 2 millimeter endodontic access cavity space.

15. The method of claim 3 wherein:
the method comprises removing pulp tissue that remains in the pulp horn using an ultrasonic back action non-cutting instrument.

16. A device for removing pulp tissue from a pulp cavity of a tooth, the device comprising:
a source of carrier fluid;
a supply of particles;
a nozzle having an inlet in fluid communication with the source of carrier fluid and the supply of particles, the nozzle having an outlet for spraying a mixture of the carrier fluid and the particles,
wherein an outlet axis of the outlet of the nozzle is positioned at an acute angle with respect to an inlet axis of the inlet of the nozzle.

17. The device of claim 16 wherein:
the particles have an average particle size of 50 to 250 microns.

18. The device of claim 16 wherein:
the particles comprise aluminum tri-hydroxide.

19. The device of claim 16 wherein:
the carrier fluid is water.

20. The device of claim 16 wherein:
the acute angle is in a range of 15 to 75 degrees.

21. The device of claim 16 wherein:
the outlet of the nozzle has a first outer surface opposite a second outer surface of the inlet of the nozzle,
the first outer surface and the second outer surface face away from each other, and
a distance from the first outer surface to the second outer surface is less than three millimeters.

22. A device for removing pulp tissue from a pulp cavity of a tooth, the device comprising:
a handle;
a tip having a distal end and a proximal end connected to the handle; and
one or more spinning brushes attached to the distal end of the tip.

23. The device of claim 22 wherein:
each spinning brush has a hardness less than a hardness of dentin.

24. The device of claim 22 wherein:
the tip has a bend defining an acute angle between an axis of the distal end of the tip and axis of the proximal end of the tip.

25. The device of claim 24 wherein:
the acute angle is in a range of 15 to 75 degrees.

26. The device of claim 22 wherein:
the distal end of the tip has a first outer surface opposite a second outer surface of the proximal end of the tip,
the first outer surface and the second outer surface face away from each other, and
a distance from the first outer surface to the second outer surface is less than three millimeters.

27. A device for removing pulp tissue from a pulp cavity of a tooth, the device comprising:
a handle;
a tip having a distal end and a proximal end connected to the handle; and
a cutting edge at the distal end of the tip,
wherein the tip has a bend defining an acute angle between an axis of the distal end of the tip and an axis of the proximal end of the tip.

28. The device of claim 27 wherein:
the cutting edge has a hardness less than a hardness of dentin.

29. The device of claim 27 wherein:
the acute angle is in a range of 15 to 75 degrees.

30. The device of claim 27 wherein:
the distal end of the tip has a first outer surface opposite a second outer surface of the proximal end of the tip,
the first outer surface and the second outer surface face away from each other, and
a distance from the first outer surface to the second outer surface is less than three millimeters.

31. A device for removing pulp tissue from a pulp cavity of a tooth, the device comprising:
a handle; and
a tip having a distal end and a proximal end connected to the handle, the distal end of the tip emitting ultrasonic waves,
wherein the tip has a bend defining an acute angle between an axis of the distal end of the tip and an axis of the proximal end of the tip.

32. The device of claim 31 wherein:
the distal end of the tip has a first outer surface opposite a second outer surface of the proximal end of the tip,
the first outer surface and the second outer surface face away from each other, and
a distance from the first outer surface to the second outer surface is less than three millimeters.

33. The device of claim 31 wherein:
the acute angle is in a range of 15 to 75 degrees.
